(19) United States
(12) Patent Application Publication
(10) Pub. No.: US 2018/0218337 A1
(43) Pub. Date: Aug. 2, 2018

(54) SYSTEM AND METHODS FOR ANALYZING AND REDUCING NO-SHOW RATES

(71) Applicant: Mikhail Polatov, New York, NY (US)

(72) Inventor: Mikhail Polatov, New York, NY (US)

(73) Assignee: Visit Census, LLC, Albany, NY (US)

(21) Appl. No.: 15/878,680

(22) Filed: Jan. 24, 2018

Related U.S. Application Data
(60) Provisional application No. 62/452,558, filed on Jan. 31, 2017.

(51) Int. Cl. G06Q 10/10; G06F 17/30; G06N 5/02

(52) U.S. Cl. CPC G06Q 10/1095; G06N 5/022; G06F 17/3089

(57) ABSTRACT

A centralized visit database system including a database engine (DBE) for loading and storing data in electronic communication with a data capture engine (DCE) for capturing client and visit information across multiple service providers and scheduling software systems, a rate engine (RE) for calculating no-show rate statistics, a user interface engine (UIE), and an external API engine (EAPI). A method of using a centralized visit database system by searching for client data, calculating no-show statistics, generating ratings, building a schedule, and displaying the schedule.

### BACKGROUND OF THE INVENTION

### 1. Technical Field

The present invention relates to booking appointments for clients and reducing no-show rates.

### 2. Background Art

Many service professionals experience problems with high no-show rates which have significant economic impact on their business. Simple visit overbooking (double-booking) techniques often leave clients dissatisfied with extra wait time. To date, most predictive models usually do not work well on limited visit datasets.

Currently, there are different methods and implementations to deal with no-show clients such as automated SMS/email reminders and manual phone calls to a client. Some businesses try to employ complex predictive models that attempt to calculate the probability of a no-show based on past visit history.

For example, U.S. Patent Application Publication No. 20160180256 to Renaud, et al. discloses an apparatus, program product, and method collect and maintain booking histories for customers within one or more computerized databases to incorporate the past behaviors of customers booked for service components when forecasting show probabilities for those service components. A show rate forecast operation, for example, can be used to determine a show probability for a service component based upon both a personal show probability for one or more customers booked on the service component and anonymous statistical show probability data relevant to the service component.

U.S. Patent Application Publication No. 20160253462 to Zhong, et al. discloses a patient appointment schedule that is generated for an open access time window (typically a single day). A no show likelihood is assigned for each time slot based on past patient no show (missed appointment) information, and time slots whose no show likelihood exceeds a threshold are designated as open access time slots. The patient appointment schedule is displayed. During scheduling, an unfilled time slot may be allocated to a patient so as to be converted to a filled time slot, or conversely a filled time slot may be deallocated so that the filled time slot is converted to an unfilled time slot. However, unfilled open access time slots are allocated to patients only during the open access time window, so as to accommodate patients who should be seen on the same day they call.

U.S. Patent Application Publication No. 20150242819 to Moses, et al. discloses systems and methods for scheduling appointments efficiently by generating predictive models using historical appointment data and using these models to predict in advance whether an appointment will be a no-show or a cancellation. The predictive models can be based on logistic regression methods, support vector machines, or neural networks. If the model predicts that an appointment in a particular time-slot will probably be a no-show/cancellation, a scheduling system can decide to double-book that time-slot in order to reduce scheduling inefficiency.

U.S. Pat. Nos. 8,671,009 and 8,244,566 to Coley, et al. discloses computer-based apparatuses and computer-implemented methods for providing an automated computer network-based, or online, appointment scheduling service through which registered customers are individually capable of scheduling an appointment with a plurality of businesses that are also registered with the online appointment scheduling service. The application describes a reliability rating for each registered customer that is based on the reliability of the customer showing for scheduled appointments for all (or several) of the businesses registered with the online appointment scheduling service, not just one business. In addition, the application describes an optimization algorithm for controlling the start times presented to a customer when selecting an appointment time that seeks to cluster the new appointment to existing appointments for the business in order to reduce time gaps during the day for the business/service provider that are of insufficient duration to schedule other appointments for other customers of the business.

These existing no-show predictive methods and systems employ visit datasets that are limited to either a specific service professional, or a closed network that is handled and covered by a specific scheduling software. All known to date existing systems only operate in a standalone mode and do not share information across multiple and different platforms. Currently, there is no open or proprietary standard to share or exchange visit/client information across different scheduling systems. Therefore, there is a need for a centralized cross-platform system that can reduce no-show rates effectively by integrating and working with multiple businesses.

### SUMMARY OF THE INVENTION

The present invention provides for a centralized visit database system including a database engine (DBE) for loading and storing data in electronic communication with a data capture engine (DCE) for capturing client and visit information, a rate engine (RE) for calculating no-show rate statistics, a user interface engine (UIE), and an external API engine (EAPI).

The present invention provides for a method of using a centralized visit database system by searching for client data, calculating no-show statistics, generating ratings, building a schedule, and displaying the schedule.

### DESCRIPTION OF THE DRAWINGS

Other advantages of the present invention are readily appreciated as the same becomes better understood by reference to the following detailed description when considered in connection with the accompanying drawings wherein:

FIG. 1 is a diagram of the flow of information between the components of the system of the present invention; and

FIG. 2 is a screenshot of a schedule grid generated by the system of the present invention.

### DETAILED DESCRIPTION OF THE INVENTION

The system and method of the present invention allow for the improvement of prediction of client no-shows by using models that operate on information from past visits scheduled across different service professionals regardless of industry they operate in. As a result, all participants of the system benefit from collective collaboration on gathering visit data and building a truly global and centralized database, which results in better predictive model outcomes.

All necessary visit data is captured from existing scheduling software that is used by a service professional without any additional software installation. The system has a predefined set of data capture rules for most popular scheduling systems, as well as simple and intuitive mechanisms to define new rules. Alternatively, a scheduling software provider can choose to integrate with the system through an External API (application processing interface) to provide client and visit information and build a schedule, retrieve client scores and other schedule properties, and access other system functionality. Any business that deals with scheduling visits for its clientele can utilize this system and its methods to reduce no-show rates and increase their revenue. The simple, intuitive, and non-intrusive setup is useful for many businesses and can have immediate positive impact on revenue.

“Operator” as used herein, refers to any person or an external API user accessing and using the system of the present invention.

“Computer” as used herein can refer to a desktop computer or laptop, or a mobile device such as a smartphone or tablet, and includes any required non-transient computer readable media required to run and/or store software.

“Screen” as used herein can refer to a display of a digital graphical user interface associated with any of the computers described above. The screen can be touch activated or static.

The system 10 of the present invention is a centralized visit database. The system 10 is capable of capturing and storing client visit information into a database with or without using any integration with a local scheduling software including both non-medical software and Electronic Medical Records (EMR) software in a HIPAA compliant environment. This allows more accurate central processing of no-show rate statistics and future no-show prediction.

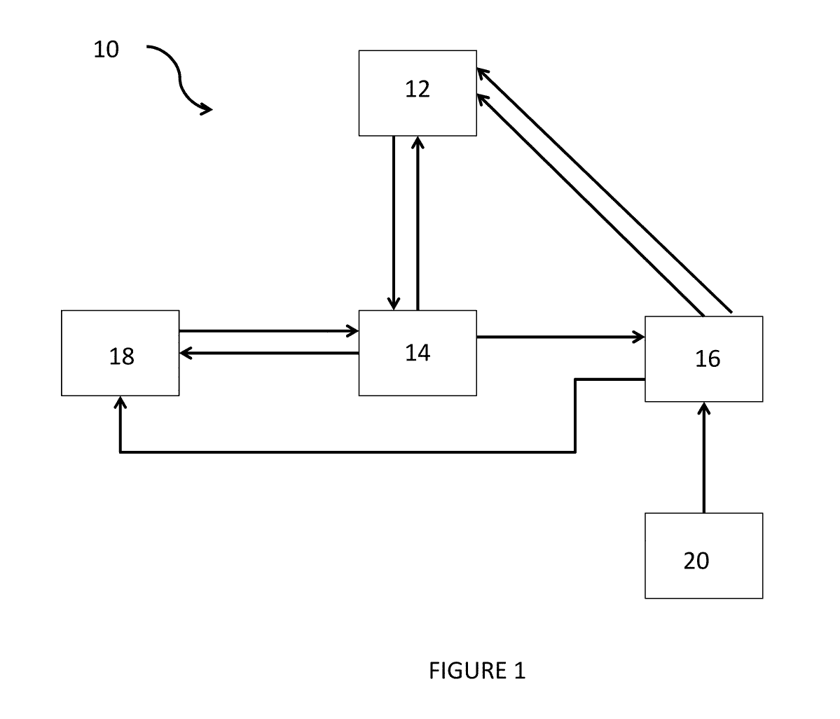

The system 10, shown in FIG. 1, can utilize cloud-based software and can include the following components: a database engine (DBE) 12 for loading and storing data, a data capture engine (DCE) 14 for capturing client and visit information, a rate engine (RE) 16 for calculating no-show rate statistics, a user interface engine (UIE) 18, and an external API engine (EAPI) 20. The DBE 12, RE 16, UIE 18, and EAPI 20 are cloud based, decoupled, and can reside in the same or different networks. All of the system 10 components are in electronic communication.

The DBE 12 performs the functions of loading/storing visit properties, loading/storing visit status, and loading/storing system configurations.

The DCE 14 is a module running inside of the operator's web browser. The DCE 14 is controlled by a set of rules. Each rule describes what type of information to capture, and where that information is coming from. The rule is tied to work with specific program and window. There are several types of rules. An edit control or static text rule describes a window control with specific ID and coordinates (x, y) where text is extracted from the specified window control. [symbol] A screen area rule—(x, y, width, height) describes an area inside of the main window of the specified program where text recognition is performed by using an OCR (optical character reader) in an attempt to extract text. [symbol] A web-based rule describes a content script within a web-plugin that runs in a specified web-based scheduling system and extracts a text from a web controls matched by a control ID. Rules can be combined to capture composite information. For example, client's First and Last name can be defined to capture from two different window controls or screen sections.

The DCE 14 performs the following functions. It loads rules from the DBE 12. It displays the top-most floating button on a computer screen with an action to initiate client and visit data capture. The DCE 14 captures client and visit information using any of the following methods. In one method, all running programs and windows on the operator's computer can be enumerated and the best match for all rules can be found by applying them for each running program, window, or web-page. In a second method, DCE 14 web-browser plugin can inspect the currently displayed web page and match rules against rendered fields on the page. In a third method, manual input of all required client information can be accepted in case the screen or web-based capture is not available. In a fourth method, a client tag can be used to find an existing client in the DBE 12 in the format of an eight character identifier composed of the first character of the first name, first character of the last name, and the day of birth in the format MMDDYY, or any other suitable generated tag that can quickly identify a client. The DCE 14 also validates and normalizes captured data. In a fifth method, all client and visit information can be entered manually or submitted through EAPI 20. Finally, the DCE 14 sends all captured data back to the cloud into the DBE 12.

The RE 16 calculates no-show rate statistics and performs the following functions. The RE 16 defines visit properties comprising at least client full name, client's zip code, service providers, office/business location, company, and/or insurance (if applicable). The RE 16 receives captured or manually entered visit properties data from the DCE 14. The RE 16 searches existing clients through the DBE 12 based on visit properties, and registers a new client if they are not found based on information provided by the DCE 14. The RE 16 resolves conflicts when multiple clients matched by name and date of birth by calculating distance between the client's zip code and attending office. The RE 16 can query the DBE 12 for historical information within visit properties. The RE 16 calculates no-show rate statistics for each item in the visit properties as a percentage of kept visits across all service providers. The RE 16 calculates a visit score and aides the operator with the double-booking decision process. The RE 16 applies no-show rate statistics for every visit as it builds a schedule for a given office on a given day. When an operator tries to book a client to an already occupied slot, the RE 16 can recommend double-booking based on relation between occupied slot's score and the client's score. The client's score is calculated by an adaptive algorithm that uses statistical, regression, or predictive models utilizing all historical visits with similar visit properties across all service providers. The algorithm can choose to use local client historical dataset visits only once the number of local visits becomes statistically significant, otherwise it can use historical data across multiple providers and locations.

The UIE 18 displays information and receives an operator input through a web browser and can perform the following functions. The UIE 18 can book a visit, cancel a visit, change the status of a future visit as pending, confirmed, or unconfirmed. The UIE 18 can change the status of a past visit as kept, kept with follow up, or missed. The UIE 18 can accept confirmation by an operator of signed HIPAA compliance documentation. The UIE 18 can track clients with missed follow up visits. The UIE 18 can remind the operator to confirm future visits, or remind to confirm daily attendance or kept or missed appointments. The UIE 18 can display no-show rate statistics on client and different categories and probability of a visit to be kept, and display a schedule report for one or more service providers within given office on a given day on [symbol] compact multi-functional schedule grid. [symbol] The UIE 18 can also provide an interface to configure software behavior by managing users and their roles and properties, configuring schedules for service providers, configuring capture rules for the DCE 14, configuring EAPI 20 access and settings, as well as other system core functionality.

The EAPI 20 provides an application programming interface for external software systems. The EAPI 20 provides an authorized access to DBE 12 and RE 16 functionality.

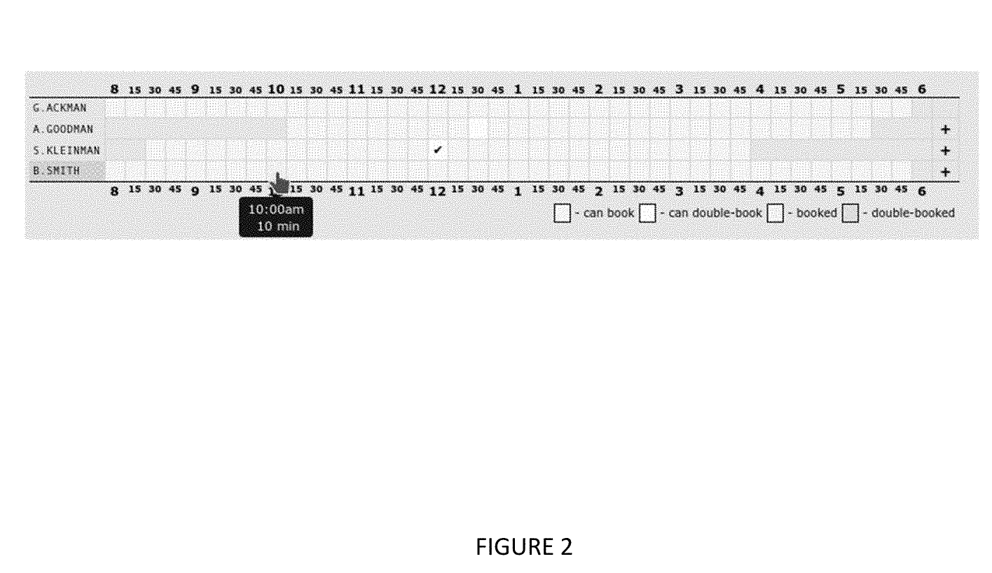

The system 10 is used in the following method of using the centralized visit database system and predicting client no-shows. Most generally, the method includes searching for client data, calculating no-show statistics, generating ratings, building a schedule, and displaying the schedule. More specifically, an operator opens up a web browser to access the system 10. The UIE 18 generates a login page and sends it back to the web browser. The operator logs in after the system 10 checks their credentials. The operator enters client information by one of the following methods: using a client tag, providing full client details (name, date of birth, zip code), or by invoking data capture through the DCE 14 by clicking on a special button on the screen/graphical user interface, or by submitting a client tag or full client and visit information via EAPI 20. The entered or captured client data is sent back to the system 10 where the RE 16 searches for it in the DBE 12. The RE 16 calculates no-show statistics on visit properties, generates ratings, builds a schedule on the specified [symbol] day for all providers in the specified office, and sends the data to either EAPI 20 or the UIE 18. The [symbol] UIE 18 builds a view to represent no-show statistics for every item in visit properties, and then the UIE 18 builds a compact multi-functional schedule grid (such as shown in FIG. 2). The no-show statistics view and schedule grid are sent back to the operator's web browser to display. [symbol] The multi-functional schedule grid can accept commands for the current mode (schedule or cancel visits), which the operator can perform. [symbol] The grid is used to show a schedule for all service providers in the office on a given day. Each cell represents a time-slot and color-codes visit(s) state. An operator can book, re-book, double-book, cancel, or change a visit state as kept, kept with follow up, missed, confirmed, unconfirmed, pending, or as signed HIPAA compliance documentation. Different colors, different initials, or different icons can be used for different states. An action on the grid is performed by using an input device such as a mouse or touchscreen by clicking or touching on:

1. a time-slot with the resulting action of:

a) a contextual change of the color reflecting a new time-slot state,

b) showing an additional contextual dialog allowing to perform an action with extended options.

2. an expand/collapse icon with the result of showing or hiding an additional pane with detailed time-slot utilization for the specified provider.

3. an extended command showing a hint, resulting in:

a) action performed based on the command,

b) showing an additional contextual dialog allowing to perform extended actions.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A centralized visit database system comprising a database engine (DBE) for loading and storing data in electronic communication with a data capture engine (DCE) for capturing client and visit information across multiple service providers and scheduling software systems, a rate engine (RE) for calculating no-show rate statistics, a user interface engine (UIE), and an external API engine (EAPI).

2. The centralized visit database system of claim 1, wherein said DBE, RE, UIE, and EAPI are cloud based.

3. The centralized visit database system of claim 1, wherein said DBE loads/stores visit properties, loads/stores visit status, and loads/stores system configurations.

4. The centralized visit database system of claim 1, wherein said DCE is a module that runs inside a web browser.

5. The centralized visit database system of claim 1, wherein said DCE loads rules from said DBE.

6. The centralized visit database system of claim 1, wherein said DCE captures client and visit information and sends all captured data to said DBE.

7. The centralized visit database system of claim 6, wherein said DCE captures client and visit information by a method chosen from the group consisting of applying a best match for all rules for each running program/window/web-page, matching rules against rendered fields on a web-page, manually inputting client information, using a client tag, and submitting through said EAPI.

8. The centralized visit database system of claim 1, wherein said RE defines visit properties chosen from the group consisting of client full name, client's zip code, service providers, office/business location, company, and insurance.

9. The centralized visit database system of claim 8, wherein said RE calculates no-show rate statistics for each item in said visit properties as a percentage of kept visits across all service providers.

10. The centralized visit database system of claim 9, wherein said RE recommends double-booking based on relation between an occupied slot's score and a client's score.

11. The centralized visit database system of claim 1, wherein said UIE displays information and receives operator input through a web browser.

12. The centralized visit database system of claim 1, wherein said UIE performs functions chosen from the group consisting of booking a visit, canceling a visit, changing the status of a future visit, changing the status of a past visit, accepting confirmation by an operator of signed HIPAA compliance documentation, reminding the operator to confirm future visits, reminding the operator to confirm daily attendance or kept or missed appointments, displaying no-show rate statistics on client and different categories and probability of a visit to be kept, displaying a schedule report for one or more service providers within given office on a given day, and combinations thereof.

13. The centralized visit database system of claim 1, wherein said EAPI provides an authorized access to said DBE and RE functionality.

14. The centralized visit database system of claim 1, wherein said multiple service providers and scheduling software systems include non-medical software and electronic medical record software.

15. A method of using a centralized visit database system and predicting client no-shows, including the steps of:
searching for client data;
calculating no-show statistics;
generating ratings;
building a schedule; and
displaying the schedule.

16. The method of claim 15, wherein said searching step further includes the steps of an operator opening a web browser to access the visit database system, a user interface engine generating a login page for the web browser, and the operator logging in the centralized visit database system.

17. The method of claim 15, wherein said searching step further includes the steps of the operator entering client information by a method chosen from the group consisting of using a client tag, providing full client details, and by invoking data capture through a data capture engine by clicking on a button on a screen, sending the client data to the centralized visit database system, and a rate engine searching for the client data in a data capture engine.

18. The method of claim 15, wherein said calculating step is further defined as the rate engine calculating no-show statistics on visit properties.

19. The method of claim 15, wherein said generating step is further defined as the rate engine generating ratings.

20. The method of claim 15, wherein said building a schedule step is further defined as the rate engine building a schedule on a specified day for all providers in a specified office and sending data to the user interface engine.

21. The method of claim 15, wherein said displaying step is further defined as the user interface engine building a view that represents no-show statistics for every item in visit properties, building a multi-functional schedule grid, and displaying the no-show statistics and grid to an operator.

22. The method of claim 15, further including the steps of the operator performing an action on the grid chosen from the group consisting of booking, re-booking, double-booking, canceling, changing a visit state as kept, changing a visit state as kept with follow up, changing a visit state as missed, changing a visit state as confirmed, changing a visit state as unconfirmed, changing a visit state as pending, and changing a visit state as signed HIPAA compliance documentation.

23. The method of claim 15, wherein said searching for client data step, calculating no-show statistics step, generating ratings step, and building a schedule step are communicated through an external API engine (EAPI).
